(19) United States
(12) Patent Application Publication
(10) Pub. No.: US 2010/0009030 A1
(43) Pub. Date: Jan. 14, 2010

(54) METHOD OF IMPROVING FERMENTABILITY OF EARLY FLOCCULATING MALT

(75) Inventors: Mao Sugihara, Tokyo (JP); Saori Yamauchi, Tokyo (JP); Osamu Ogane, Tokyo (JP)

Correspondence Address: FOLEY AND LARDNER LLP;SUITE 500, 3000 K STREET NW, WASHINGTON, DC, 20007, US

(73) Assignee: KIRIN BEER KABUSHIKI KAISHA, TOKYO (JP)

(21) Appl. No.: 12/311,935

(22) PCT Filed: Jan. 11, 2007
(86) PCT No.: PCT/JP2007/050238

§ 371 Date: Sep. 3, 2009

(30) Foreign Application Priority Data
Nov. 2, 2006 (JP) 2006-298660

(51) Int. Cl. C12C 11/06; C12C 7/00

(52) U.S. Cl. 426/16; 426/62; 426/615

(57) ABSTRACT

It is to provide a method that enables manufacture of beer or HAPPOSHU with good fermentation with yeast and having rich flavor, by improving the fermentability of premature yeast flocculation malt (PYF malt) (malt comprising factors causing early flocculation of yeast) even when PYF malt is used in the manufacture of beer or HAPPOSHU. In the manufacture of beer or HAPPOSHU using premature yeast flocculation malt (PYF malt), tannic acid is added and treated to wort and/or yeast used for fermentation, to improve the fermentability of premature yeast flocculation malt. In the present invention, in order to improve fermentability of early flocculatin malt, tannic acid is added and treated to wort before addition of yeast or to wort fermentation solution after adding yeast, or to yeast for adding to wort, in the manufacturing step of beer or HAPPOSHU. Preferred tannic acids used in the present invention include gallotannin, tara-tannin, gallic tannin (hydrolysable tannin) and persimmon tannin (condensed tannin).

### TECHNICAL FIELD

The present invention relates to a method for improving fermentability of premature yeast flocculation malt (PYF malt) (malt comprising factors causing early flocculation of yeast), by using tannic acid in the manufacture of beer or HAPPOSHU (low-malt beer) using PYF malt.

### BACKGROUND ART

When manufacturing alcohols comprising malt as raw material such as beer and HAPPOSHU, sometimes a phenomenon called “early flocculation phenomenon” is observed during the fermentation step. This is a phenomenon wherein yeast flocculates and precipitates, while assimilable sugar in yeast is still present in the wort during the fermentation step, particularly in the late phase of the fermentation. When yeast flocculates and precipitates, the progress of fermentation stops. It is known that when this phenomenon occurs, the manufactured products would be below standard with insufficient fermentation, and it would be a significant loss when beer etc. are brewed using oat having early flocculating property as raw material.

In order to solve the problem of early flocculation phenomenon in the manufacture of alcohols comprising malt as raw material, many studies have been made from a long time ago. As a result, it has been revealed that this early flocculation phenomenon is caused by high-molecular acidic polysaccharides included in malt, derived from the raw material oats. However, it has not been known whether a factor causing the early flocculation phenomenon (herein after referred to as “early flocculating factor”) is present in the raw material oat, or whether it is generated during the malting step. However, recently it has been revealed that the early flocculating factors are in some cases generated during the oat manufacturing step, while in other cases they are originally present in the raw material oat (J. Inst. Brew., 97, 359-366, 1991; Journal of Japan Society for Bioscience, Biotechnology and Agrochemistry, 71, 381, 1997; Japanese Laid-Open Patent Application No. 10-179190). However, no studies have been developed so far concerning a method to solve the early flocculation phenomenon by eliminating the early flocculating factors.

Therefore, conventionally, in the brewing of fermented malt beverages comprising barley as raw material such as beer and HAPPOSHU, the presence or absence of early flocculating factors in barley is confirmed to select only barley malt which does not induce early flocculation phenomenon. As a conventional method to confirm the presence or absence of early flocculating factors in barley, a method comprising a fermentation test was used, which method comprises to actually malting barley in a small scale, prepare wort from the malt, actually allow fermentation of wort by using yeast, and to confirm the presence or absence of early flocculating factors in barley from the progress of fermentation (K. Morimoto, et. al., Rept. Res. Lab. Kirin Brewery Co., Ltd., 1863, 1975).

The above-mentioned conventional method comprises to confirm the presence or absence of early flocculating factors in barley by performing the actual brewing in a small scale, and the results are reliable. However, about 7 days were necessary to prepare malt and then wort, and about 8 days to confirm the presence or absence of early flocculating factors in barley from the progress of fermentation. Thus a period of about half a month was necessary to confirm the presence or absence of early flocculating factors in barley. In order to shorten the period of this fermentation test, a method of determining the presence or absence of early flocculating factors in the raw material oat, comprising treating the test raw material malt with enzyme, adding the obtained enzyme-treated products to the synthesized wort to make a fermentation test raw material, and performing a fermentation test 48 hours later (Japanese Laid-Open Patent Application No. 10-179190); and a method not comprising a fermentation test (Proc. Congr. Eur. Brew. Conv. 28:397-406,2001) have been disclosed. However, since they had drawbacks of time required for fermentation test, or accuracy of quantitative determination, the methods were not complete. Therefore, a quick measurement method for measuring factors causing early flocculation of yeast contained in brewing raw materials, within a short period and in a simple manner, without conducting a fermentation step as in the conventional methods, has been developed (PCT/JP2005/001199).

As it is stated in the above, elucidation of early flocculating factors has progressed, and a measuring method for quickly measuring early flocculating factors has been developed, while the actual coping strategy in the brewing of fermented malt beverages such as beer and HAPPOSHU is to confirm the presence or absence of early flocculating factors in barley, and to select only barley malts not causing early flocculation phenomenon. The early flocculation phenomenon of yeast in malt (early flocculating property) is a phenomenon wherein yeast flocculates and precipitates, while assimilable sugar is still present in wort during the late phase of the main fermentation, and which is caused by wort. When early flocculation phenomenon occurs due to PYF malt (malt comprising factors causing early flocculation of yeast), it induces insuffiency of floating yeast, insuffiency of sugar consumption during the main fermentation and maturation steps, thereby causing disharmony of flavor such as acetoaldehyde, diacetyl, and feeling of remaining sugar (poor fermentation of PYF malt).

Therefore, as a practical countermeasure taken at a faculty at present, use by blending with good malt (1 to 10%) can be exemplified. However, in such use by blending with good malt, the used amount of PYF malt is restricted, and it would necessitate storing PYF malt for a long time before use, which may necessitate a long time-occupation of silo, or induce deterioration of the malt quality. Further, particularly in the case of malt having strong flocculation property, disposal of malt is also considered at present. As such, the actual method for coping with PYF malt has many drawbacks in quality and cost.
Patent document 1: Japanese Laid-Open Patent Application No. 10-179190
Patent document 2: PCT/JP2005/001199
Non-Patent document 1: J. Inst. Brew., 97, 359-366, 1991
Non-Patent document 2: Journal of Japan Society for Bioscience, Biotechnology and Agrochemistry, 71, 381, 1997
Non-Patent document 3: K. Morimoto, et. al., Rept. Res. Lab. Kirin Brewery Co., Ltd., 1863, 1975
Non-Patent document 4: Proc. Congr. Eur. Brew. Conv. 28:397-406, 2001

### DISCLOSURE OF THE INVENTION

### Object to be Solved by the Invention

The object of the invention is to provide a method that enables manufacture of beer or HAPPOSHU with a good fermentation of yeast and having rich flavor, by improving the fermentability of PYF malt (malt comprising factors causing early flocculation of yeast), even when using PYF malt in the manufacture of beer or HAPPOSHU. Herein, improvement of “fermentability” of PYF malt relates to enhancement of “yeast flotage” during the fermentation period, promotion of “extract (sugar) consumption”, and decrease of “off-flavor such as acetaldehyde or diacetyl, etc.” Specifically, the object of the invention is to provide a method that enables manufacture of beer or HAPPOSHU with good fermentation and having rich flavor, by ensuring the number of floating yeast on the way of fermentation during the fermentation step, promoting extract (sugar) consumption by yeast, and further reducing the odor derived from poor fermentation such as acetaldehyde or diacetyl, even when using PYF malt in the manufacture of beer or HAPPOSHU.

### Means to Solve the Object

The present inventors made a keen study in order to solve the above object, and found out that by adding and mixing tannic acid to the wort and/or yeast used for fermentation in the manufacture of beer or HAPPOSHU using PYF malt, the fermentability of PYF malt can be significantly improved. The present invention has been thus completed. Specifically, according to the present invention, it has been found hat by adding and mixing tannic acid to the wort before addition of yeast, or to the wort fermentation solution after addition of yeast, or to yeast for adding to wort, during the manufacture step of beer or HAPPOSHU, the fermentability of PYF malt can be significantly improved. The present invention has been thus completed.

Tannic acid (tannin) can be classified in two, that is, a condensed tannic acid, wherein compounds having flavanol structure are polymerized, and a hydrolysable tannic acid wherein aromatic compounds such as gallic acid and ellagic acid and sugars such as glucose have formed a ester bond. For the improvement of fermentability of PYF malt in the present invention, either of the above tannic acid may be used. For the objective of the present invention, gallotannin, tara-tannin, gallic tannin (hydrolysable tannin) and persimmon tannin (condensed tannin) can be exemplified as particularly preferred tannic acid.

In the present invention, the added amount of tannic acid is as follows: when gallotannin is added to wort before addition of yeast, it is added at a rate of 0.1 to 3.9 g/kg malt; when gallotannin is added to wort fermentation solution after addition of yeast, it is added at a rate of 0.1 to 3.9 g/kg centrifuged yeast (2000 G·10 min) (yeast weight is determined with the proviso that a centrifugation (3000 rpm=approximately 2000 G, 10 min) has been performed; the same hereinafter); and when gallotannin is added to yeast for adding to wort, it is added at a rate of 0.01 to 0.19 g/kg centrifuged yeast (2000 G·10 min).

In the present invention, in the manufacture of beer or HAPPOSHU, by manufacturing beer or HAPPOSHU by using the method for improving fermentability of PYF malt of the present invention, the poor fermentation can be improved even when PYF malt is used, and thus it is possible to manufacture beer or HAPPOSHU of an intended quality.

In other words, the present invention relates to (1) a method for improving fermentability of premature yeast flocculation malt, comprising adding and mixing tannic acid to wort and/or yeast to be used for fermentation in the manufacture of beer or HAPPOSHU using premature yeast flocculation malt; (2) the method for improving fermentability of premature yeast flocculation malt according to (1), wherein the tannic acid is 1 or more tannic acid selected from gallotannin, tara-tannin, gallic tannin, and persimmon tannin; (3) the method for improving fermentability of premature yeast flocculation malt according to (1) or (2), wherein the addition of tannic acid is an addition to wort before addition of yeast, or an addition to wort fermentation solution after addition of yeast, or an addition to yeast for adding to wort in the manufacture of beer or HAPPOSHU.

Further the present invention is related to (4) the method for improving fermentability of premature yeast flocculation malt according to (3), comprising adding gallotannin at a rate of 0.1 to 3.9 g/kg malt relative to wort before addition of yeast; (5) the method for improving fermentability of premature yeast flocculation malt according to (3), comprising adding gallotannin at a rate of 0.1 to 3.9 g/kg centrifuged yeast (2000 G·10 min) relative to wort fermentation solution after addition of yeast; (6) the method for improving fermentability of premature yeast flocculation malt according to (3), comprising adding gallotannin at a rate of 0.01 to 0.19 g/kg centrifuged yeast (2000 G·10 min) relative to yeast solution for adding to wort; and (7) a method for manufacturing beer or HAPPOSHU using premature yeast flocculation malt, comprising adding and mixing tannic acid to wort before addition of yeast, wort fermentation solution after addition of yeast, or yeast for adding to wort, and allowing fermentation with yeast in the manufacturing step of beer or HAPPOSHU, in the manufacture of beer or HAPPOSHU using premature yeast flocculation malt.

### BRIEF DESCRIPTION OF DRAWINGS

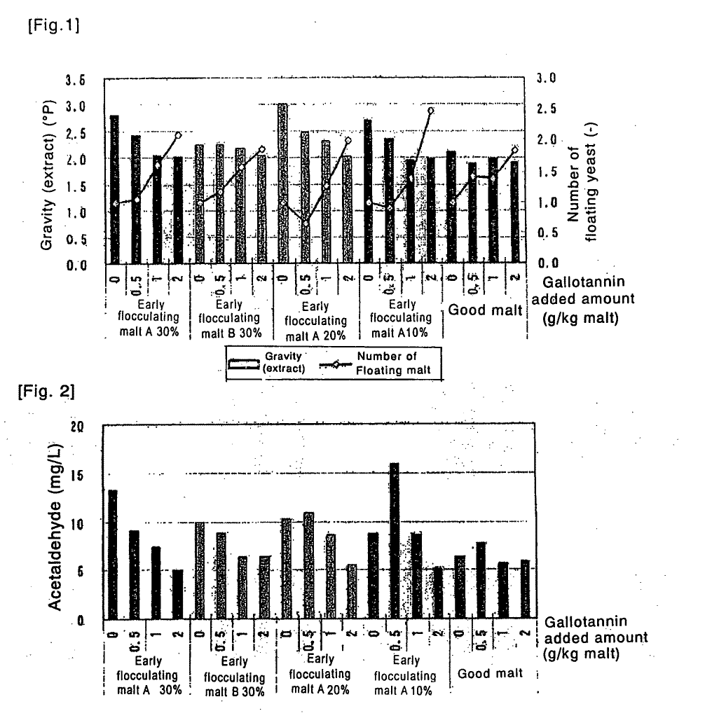

### [FIG. 1]

It is a graph showing the relationship between the rate of pale PYF malt and the gallotannin concentration, in the test on the fermentability improvement effect of gallotannin, in the Examples of the present invention (number of floating cells and gravity (extract) at day 7 of the main fermentation).

### [FIG. 2]

It is a graph showing the relationship between the rate of pale PYF malt rate and the gallotannin concentration, in the test on the fermentability improvement effect of gallotannin, in the Examples of the present invention (analysis value of acetaldehyde at day 7 of the main fermentation).

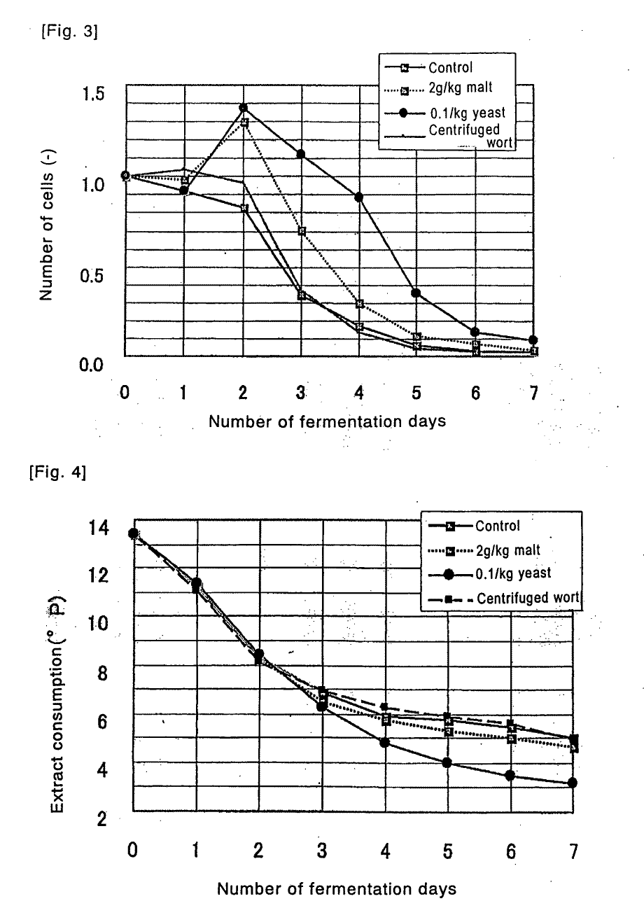

### [FIG. 3]

It is a graph showing the fermentability improvement effect of gallotannin (transition of the number of floating cells during the main fermentation) in the test on the fermentability improvement effect according to the difference of timing of adding gallotannin, in the Examples of the present invention.

### [FIG. 4]

It is a graph showing the fermentability improvement effect of gallotannin (transition of extract consumption during the main fermentation), in the test on the fermentability improvement effect according to the difference of timing of adding gallotannin, in the Examples of the present invention.

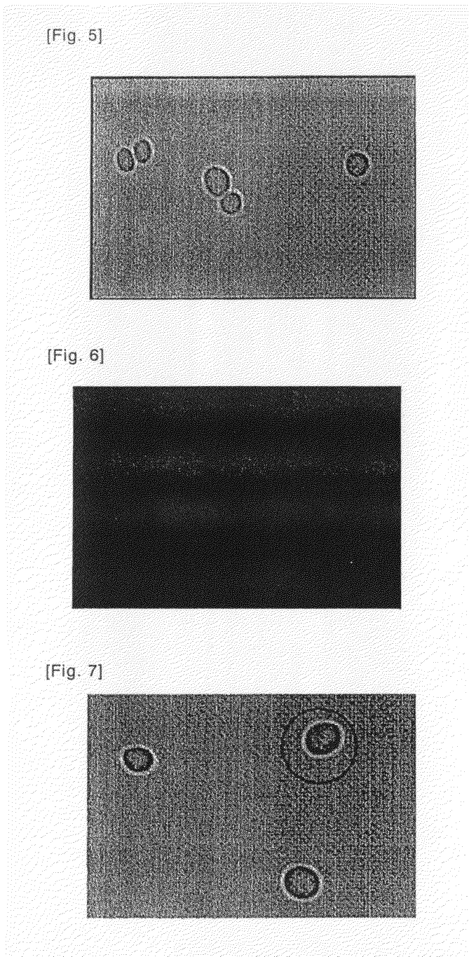

### [FIG. 5]

It is a figure showing a result of microscopical observation of yeast cell surface layer by using FITC fluorescent label attached to gallotannin, in a case where gallotannin is not added (without staining) in the Examples of the present invention.

### [FIG. 6]

It is a figure showing a result of microscopical observation of yeast cell surface layer by using FITC fluorescent label attached to gallotannin, in a case where gallotannin is not added (with staining) in the Examples of the present invention.

### [FIG. 7]

It is a figure showing a result of microscopical observation of yeast cell surface layer by using FITC fluorescent label attached to gallotannin, in a case where gallotannin is added to wort (without staining) in the Examples of the present invention.

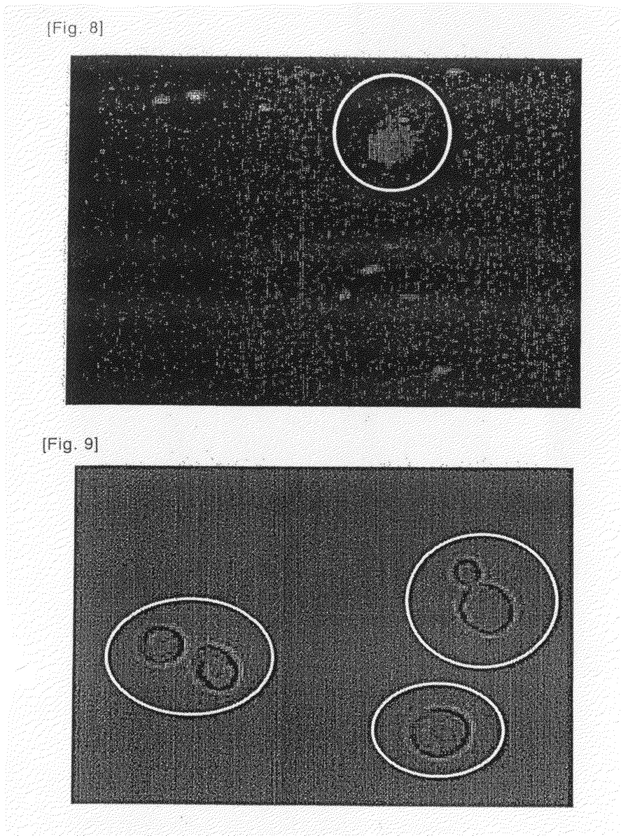

### [FIG. 8]

It is a figure showing a result of microscocpial observation of yeast cell surface layer by using FITC fluorescent label attached to gallotannin, in a case where gallotannin is added to wort (with staining) in the Examples of the present invention.

### [FIG. 9]

It is a figure showing a result of microscopical observation of yeast cell surface layer by using FITC fluorescent label attached to gallotannin, in a case where gallotannin is added to yeast (without staining) in the Examples of the present invention.

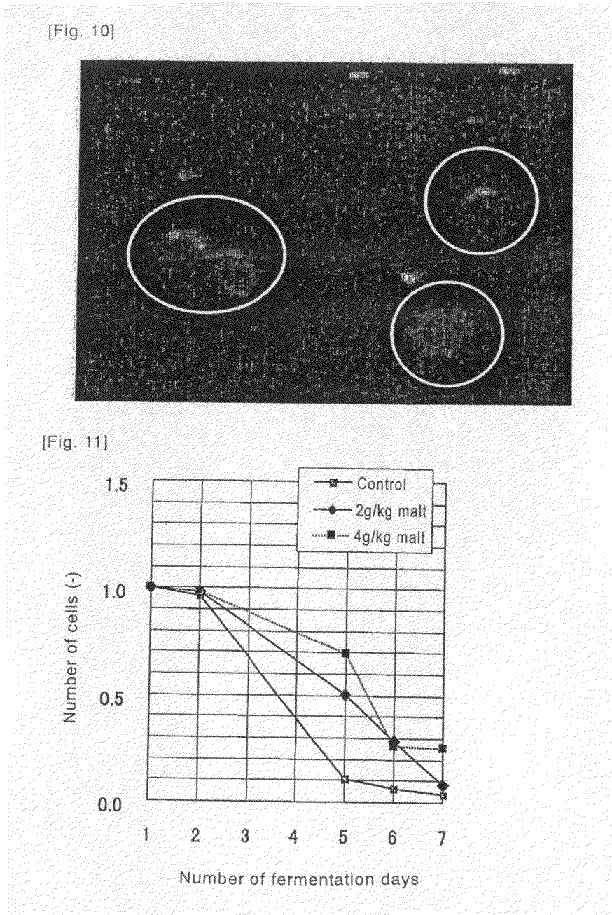

### [FIG. 10]

It is a figure showing a result of microscopical observation of yeast cell surface layer by using FITC fluorescent label attached to gallotannin, in a case where gallotannin is added to yeast (with staining) in the Examples of the present invention.

### [FIG. 11]

It is a graph showing the confirmation results of the optimum added amount of gallotannin (transition of number of floating cells during the main fermentation), in the test on influences when gallotannin is added excessively, in the Examples of the present invention.

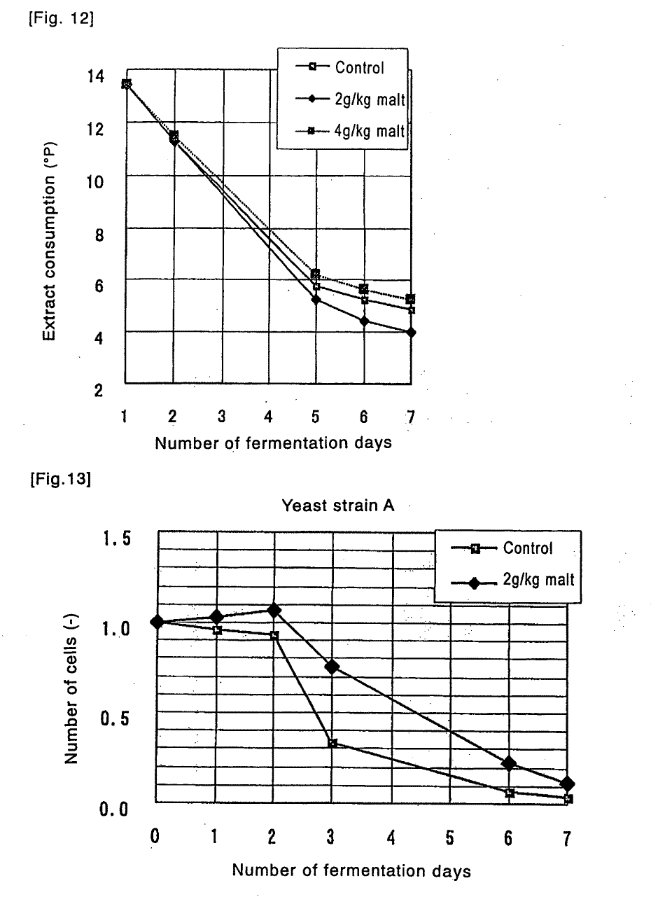

### [FIG. 12]

It is a graph showing the confirmation results of the optimum added amount of gallotannin (transition of extract consumption during the main fermentation), in the test on influences when gallotannin is added excessively, in the Examples of the present invention.

### [FIG. 13]

It is a graph showing the fermentability improvement effect of gallotannin in yeast strain A (transition of number of floating cells during the main fermentation), in the test on difference of gallotannin effect in different yeast strains, in the Examples of the present invention.

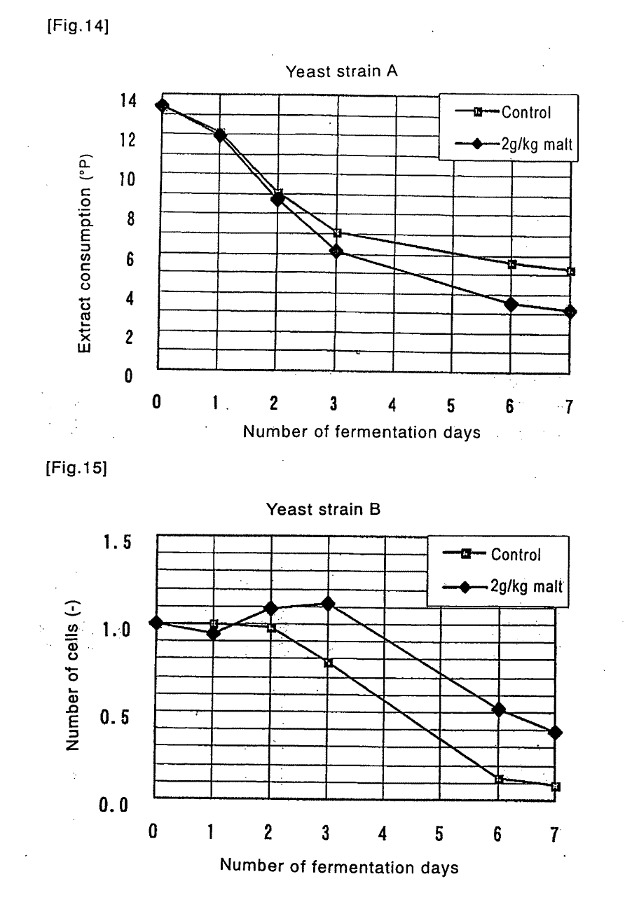

### [FIG. 14]

It is a graph showing the fermentability improvement effect of gallotannin in yeast strain A (transition of extract consumption during the main fermentation), in the test on difference of gallotannin effect in different yeast strains, in the Examples of the present invention.

### [FIG. 15]

It is a graph showing the fermentability improvement effect of gallotannin in yeast strain B (transition of number of floating cells during the main fermentation), in the test on difference of gallotannin effect in different yeast strains, in the Examples of the present invention.

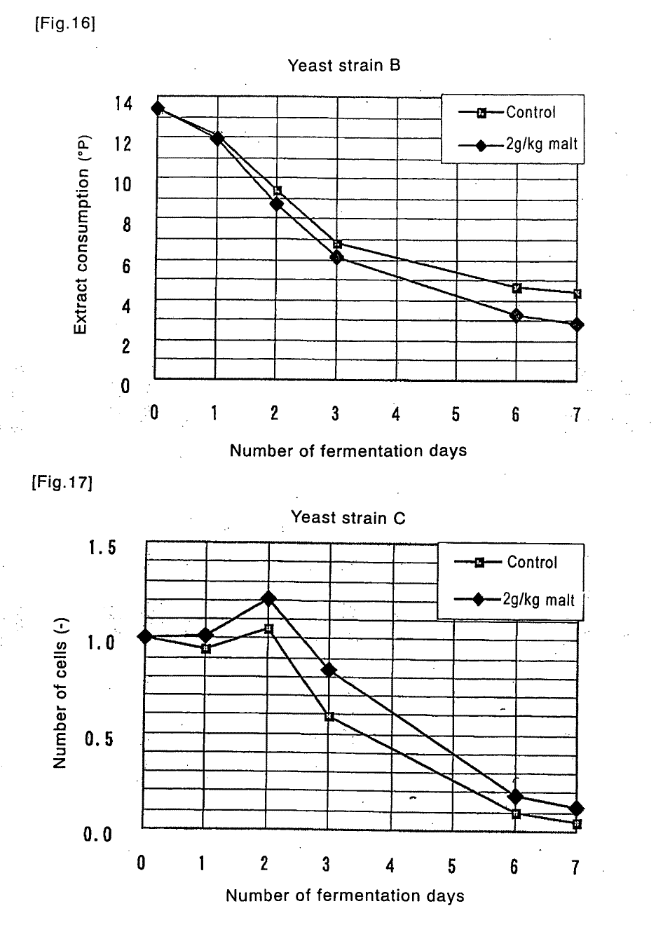

### [FIG. 16]

It is a graph showing the fermentability improvement effect of gallotannin in yeast strain B (transition of extract consumption during the main fermentation), in the test on difference of gallotannin effect in different yeast strains, in the Examples of the present invention.

### [FIG. 17]

It is a graph showing the fermentability improvement effect of gallotannin in yeast strain C (transition of number of floating cells during the main fermentation), in the test on difference of gallotannin effect in different yeast strains, in the Examples of the present invention.

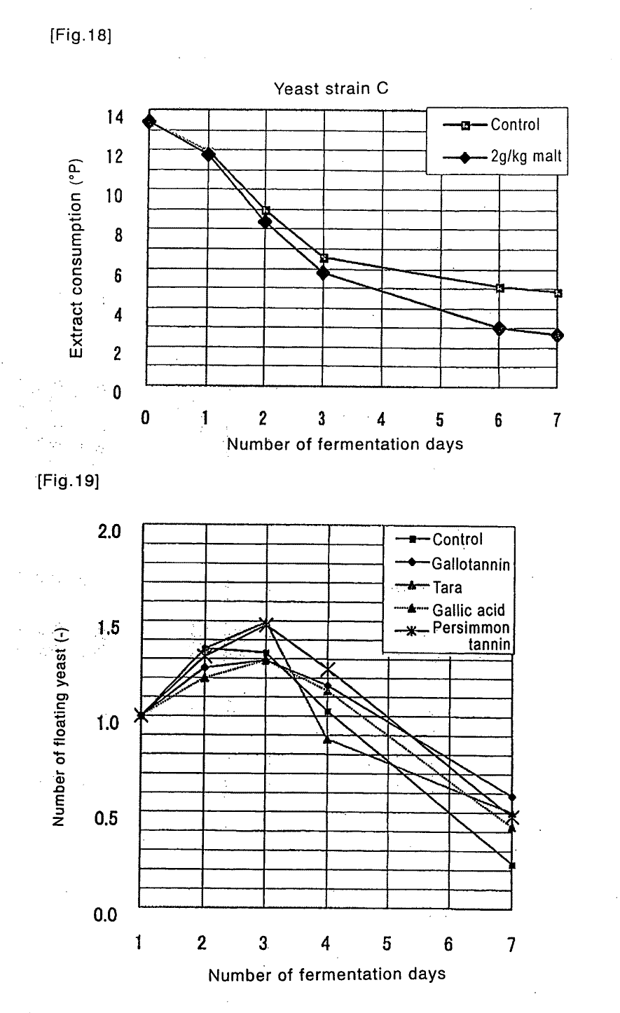

### [FIG. 18]

It is a graph showing the fermentability improvement effect of gallotannin in yeast strain C (transition of extract consumption during the main fermentation), in the test on difference of gallotannin effect in different yeast strains, in the Examples of the present invention.

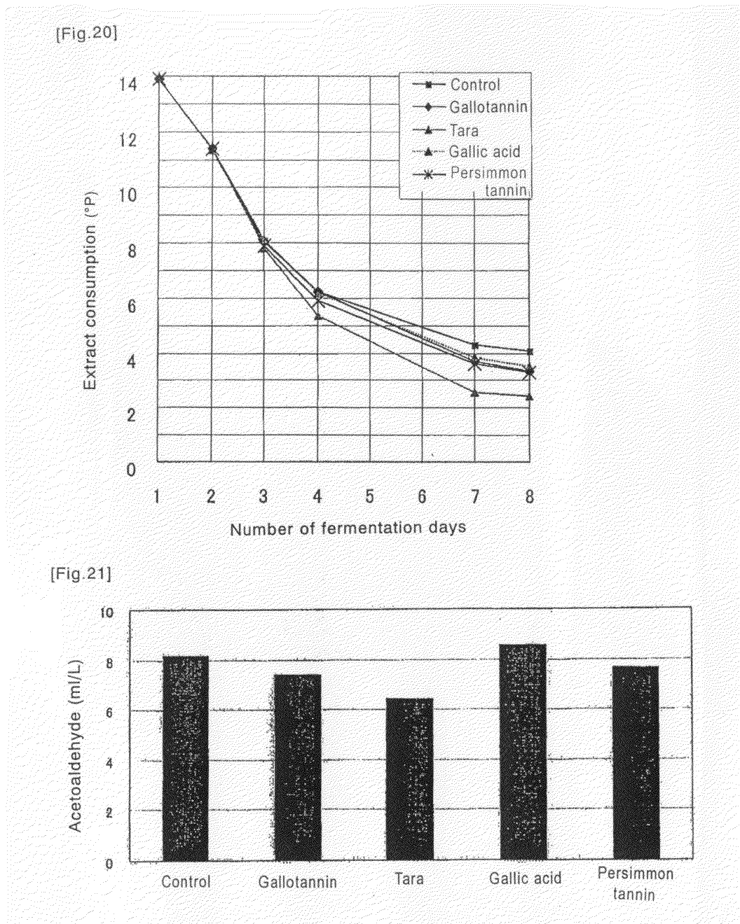

### [FIG. 19]

It is a graph showing the fermentability improvement effect of different tannic acids (transition of number of floating cells during the main fermentation) in the test on whether tannin acids other than gallotannin has a similar fermentability improvement effect, in the Examples of the present invention.

### [FIG. 20]

It is a graph showing the fermentability improvement effect of different tannic acids (transition of extract consumption during the main fermentation) in the test on whether tannin acids other than gallotannin has a similar fermentability improvement effect.

### [FIG. 21]

It is a graph showing the fermentability improvement effect of tannic acid (analysis value of acetaldehyde at day 7 of the main fermentation) in the test on whether tannin acids other than gallotannin has a similar fermentability improvement effect, in the Examples of the present invention.

### BEST MODE FOR CARRYING OUT THE INVENTION

The present invention consists of a method for improving fermentability of PYF malt by adding and treating tannic acid to wort and/or yeast to be used for fermentation, in the manufacture of beer or HAPPOSHU using PYF malt.

As for the tannic acid (tannin) used in the present invention, both condensed tannic acid and hydrolysable tannic acid may be used. With the use of the tannic acid, a fermentability improvement effect of premature yeast flocculation malt (PYF malt) may be obtained, and the level of the fermentability improvement effect varies slightly depending on the types of tannic acid. Particularly, significant effect can be confirmed in the case of gallotannin, tara-tannin, gallic tannin (hydrolysable tannin) and persimmon tannin (condensed tannin).

In the present invention, tannic acid is added at the stage of wort before addition of yeast, or at the stage of wort fermentation solution after addition of yeast, or at the stage of yeast for adding to wort, and the resultant is mixed uniformly, in the manufacture step of beer or HAPPOSHU. When tannic acid is added to hot wort, there is no problem of solubility even when tannic acid is in the form of granules, while it is preferred that tannic acid is in the form of aqueous solution when adding to cold wort or yeast. Generally, higher effect can be obtained when a higher amount of tannic acid is in contact with yeast, and it is preferred to add tannic acid just before addition of yeast (adding tannic acid to wort before addition of yeast, or adding directly to yeast). However, an effect is exhibited even when it is added to wort fermentation solution after addition of yeast.

Concerning the added amount of tannic acid in the present invention, the appropriate amount to obtain a fermentability improvement effect of PYF malt may be determined appropriately for each tannic acid. When gallotannin is added to wort before addition of yeast, it is added at a rate of 0.1 to 3.9 g/kg malt; and when gallotannin is added to wort fermentation solution after addition of yeast, it is added at a rate of 1 to 39 g/kg centrifuged yeast (2000 G·10 min). Further, when adding gallotannin to yeast for adding to wort, it is added at a rate of 0.01 to 0.19 g/kg centrifuged yeast (2000 G·10 min).

There is no particular difference between the method for manufacturing beer or HAPPOSHU with the method for improving fermentability of PYF malt of the present invention and an usual method for manufacturing beer or HAPPOSHU, except for the point that tannic is added at the stage of wort before addition of yeast or at the stage of wort fermentation solution after addition of yeast, or added directly to yeast for adding to wort, and mixing the resultant, in the manufacture step of beer or HAPPOSHU as it is stated in the above. In order to suppress astringency derived from tannic acid remaining in the beer, polyphenol may be adjusted to an adequate level by a PVPP (polyvinylpolypyrolidone) treatment during the beer filtration step (PVPP treatment is usually performed during filtration step in the manufacture of beer, etc. in order to remove polyphenol, etc.): Hideo Miyaji “Beer brewing technology” SHOKUHIN SANGYO SHINBUNSHA Co. Ltd., (Dec. 28, 1999), p. 372).

In the following, the present invention will be explained by referring to the Examples, while the technical scope of the present invention is not limited to these exemplifications.

### EXAMPLE 1

### (Fermentability Improvement Effect of Gallotannin)

The fermentability improvement effect of gallotannin in wort for HAPPOSHU using PYF malt was examined.

### (Methods)

In a 500 ml-fermentation test tube, gallotannin (0 to 2 g/malt kg=0 to 20 g/kg centrifuged yeast (2000 G·10 min)) was added to cold wort for HAPPOSHU, comprising 2 types of pale PYF malt (A, B) and 0 to 30% of good malt, and the mixture was fermented at 12° C.

### (Results)

The chemical analysis results during the fermentation process and at the termination of fermentation are shown in FIGS. 1 and 2. FIG. 1 shows the relationship between the pale PYF malt rate and the gallotannin concentration (number of floating cells and gravity (extract) at day 7 of the main fermentation). In FIG. 1, the number of floating yeast (−) shows the rate of floating yeast when the added yeast is represented as 1. FIG. 2 shows the relationship between the pale PYF malt rate and the gallotannin concentration (analysis value of acetaldehyde at day 7 of the main fermentation). In FIG. 2, the reason why aldehyde was detected at a high level in the case of when using 10% PYF malt A and adding 0.5 g/kg malt of gallotannin, is thought to be the disturbance at the time of analysis.

As it is shown in the Figures, it has been confirmed that the number of floating yeast at the late phase of fermentation increases, and the extract consumption improves by adding gallotannin to cold wort (FIG. 1). With the improvement of fermentation, off-flavor such as acetaldehyde was reduced (FIG. 2). The fermentability improvement level depends on the gallotannin concentration (when compared with 0 to 2 g/kg malt), and the effect also differed with. the type of malt. From this result, it was suggested to be necessary to adjust the gallotannin concentration to be added, according to the type of malt or the used amount of malt. As the improvement of fermentability depends on the added concentration, it can be assumed that an improvement effect can be observed even with an added amount of 0.5 g/kg malt or less. For the purpose of calculation, with an added amount of 0.1 g/kg malt, the extract consumption is improved by approximately 0.1° P. From these, the fermentability improvement effect is observed with an added amount of 0.1 g/kg malt (1 g/kg centrifuged yeast (2000 G·10 min)) or more, and it is preferred to add 0.5 g/kg malt (5 g/kg centrifuged yeast (2000 G·10 min)) or more in order to obtain a sufficient effect.

### EXAMPLE 2

### (Timing of Gallotannin Addition)

The difference of fermentability improvement effect according to the timing to add gallotannin was examined.

### (Methods)

Wort for HAPPOSHU using dark PYF malt (20%) was used in a 500 ml-fermentation test tube, and the difference of behavior under the following conditions was observed.
(a) cold wort added with gallotannin (2 g/kg malt=20 g/kg centrifuged yeast (2000 G·10 min))
(b) yeast added with gallotannin (0.1 g/kg centrifuged yeast (2000 G·10 min))
(c) cold wort added with gallotannin (2 g/kg malt) and centrifuged, and from which all proteins are completely removed.

### (Results)

The results are shown in FIGS. 3 and 4. FIG. 3 shows the fermentability improvement effect of gallotannin (transition of the number of floating cells during the main fermentation). FIG. 4 shows the fermentability improvement effect of gallotannin (transition of extract consumption during the main fermentation). As it is shown in the Figures, by adding gallotannin, the floatability of yeast increases during the intermediate phase to late phase of the fermentation, and extract consumption was confirmed to be promoted accordingly (FIGS. 3 and 4). When gallotannin was directly added to yeast, the highest level of fermentability improvement was observed. No effect was observed when wort added with gallotannin was centrifuged (3000 rpm×10 min), and protein precipitates in the wort were removed. From this result, it was suggested that the fermentability improves with the contact of gallotannin and yeast, and that the removal of protein components in the wort is not associated with the fermentability improvement. Similarly, when protein components were removed by using κ-carrageenan, no fermentability improvement effect was observed.

When directly adding gallotannin to yeast, high effect was observed even at a concentration of 1/10 or less than that of when adding to wort. From this result, it can be said that it is important to ensure gallotannin to be in contact with yeast, when adding gallotannin. For that purpose, it is recommended to add gallotannin just before adding yeast (wort immediately before addition of yeast; wort fermentation solution after addition; or direct addition to yeast). When the injection of gallotannin into wort is made too early, gallotannin will react with protein in the wort, and the majority will form a flock to precipitate. Thus it can be assumed that the gallotannin concentration to be transfered to the fermentation step will decrease, and that the fermentability improvement effect will decrease.

### (Effect of Gallotannin)

By using FITC fluorescent label attached to gallotannin, the yeast cell surface layer was observed with a microscope.

### (Results)

The results are shown in FIGS. 5 to 10. In the Figures, FIG. 5 shows a case where gallotannin is not added (without staining); FIG. 6 shows a case where gallotannin is not added (with staining); FIG. 7 shows a case where gallotannin is added to wort (without staining); FIG. 8 shows a case where gallotannin is added to wort (with staining); FIG. 9 shows a case where gallotannin is added to yeast (without staining); and FIG. 10 shows a case where gallotannin is added to yeast (with staining). As it is shown in the Figures, by adding gallotannin, fluorescent coloring of yeast cell surface layer was observed. Thus, it was suggested that gallotannin was bound to yeast surface layer. Further, it was confirmed that higher the gallotannin concentration to be in contact with yeast is, the more the surface layer will be coated as a whole.

### EXAMPLE 3

### (Maximum Added Amount of Gallotannin)

The effect of when an excessive amount of gallotannin is added was investigated.

### (Methods)

In a 500 ml-fermentation test tube, gallotannin was added in an amount of 0, 2, 4 g/kg malt=0, 20, 40 g/kg centrifuged yeast (2000 G·10 min) to cold wort for HAPPOSHU comprising pale PYF malt (30%), and the mixture was fermented at 12° C.

### (Results)

Chemical analysis results during the fermentation process and at the termination of fermentation are shown in FIGS. 11 and 12. FIG. 11 shows the confirmation results of the optimum added amount of gallotannin (transition of number of floating cells during the main fermentation), and FIG. 12 show the confirmation results of the optimum added amount of gallotannin (transition of extract consumption during the main fermentation). As it is shown in the Figures, the effect of gallotannin depends on the added concentration. However, as a decrease of extract consumption ability of yeast was observed in the case of 4 g/kg malt=40 g/kg yeast (FIG. 12), it was suggested that an addition of gallotannin in an excessive amount would reversely inhibit the fermentation. From this result, it is necessary to adjust the added amount of gallotannin to be less than 4 g/kg malt (40 g/kg centrifuged yeast (2000 G·10 min)). Similarly, when adding to yeast, as it had opposite effects when 0.2 g/kg centrifuged yeast (2000 G·10 min) was added, the optimum amount when adding to yeast should be kept to less than 0.2 g/kg centrifuged yeast (2000 G·10 min).

From these results, it was revealed that the added amount of gallotannin is less than 4 g/kg malt (40 g/kg centrifuged yeast (2000 G·10 min)) when adding to wort, and less than 0.2 g/kg centrifuged yeast (2000 G·10 min) when adding to yeast. Thus, in view of the results of Example 1, it is defined that the optimum added amount of gallotannin is 0.1 to 3.9/kg malt=1 to 39 g/kg centrifuged yeast (2000 G·10 min) when adding to wort, and 0.01 to 0.19 g/kg centrifuged yeast (2000 G·10 min) when adding to yeast.

### EXAMPLE 4

### (Type of Yeast and Gallotannin Effect)

The difference of gallotannin effect for different yeast strains was investigated.

### (Methods)

In a 500 ml-fermentation test tube, gallotannin was added to cold wort in an amount of 0.2 g/kg malt=0.20 g/kg centrifuged yeast (2000 G·10 min), by using wort for HAPPOSHU comprising dark PYF malt (20%), and the mixture was fermented at 12° C.

### (Results)

The fermentation process is shown in FIGS. 13 to 18. In the Figures, FIG. 13 shows the fermentability improvement effect of gallotannin in yeast strain A (transition of number of floating cells during the main fermentation); FIG. 14 shows the fermentability improvement effect of gallotannin in yeast strain A (transition of extract consumption during the main fermentation); FIG. 15 shows the fermentability improvement effect of gallotannin in yeast strain B (transition of number of floating cells during the main fermentation); FIG. 16 shows the fermentability improvement effect of gallotannin in yeast strain B (transition of extract consumption during the main fermentation); FIG. 17 shows the fermentability improvement effect of gallotannin in yeast strain C (transition of number of floating cells during the main fermentation); and FIG. 18 shows the fermentability improvement effect of gallotannin in yeast strain C (transition of extract consumption during the main fermentation). The fermentability improvement effect of gallotannin was confirmed in different yeast strains. From these results, it was suggested that the effect of gallotannin does not depend on the characteristics of the yeast strain.

### EXAMPLE 5

### (Fermentability Improvement Effect of Different Tannic Acids)

It was investigated whether tannic acids other than gallotannin have a similar fermentability improvement effect.

### (Methods)

In a 500 ml-fermentation test tube, different tannic acids were added to cold wort for HAPPOSHU comprising pale PYF malt (100%) in an amount of 2 g/kg malt (20 g/yeast kg), and the mixture was fermented at 12° C. The used tannic acids were tara-tannin, gallotannin, gallic acid (hydrolysable tannin), and persimmon tannin (condensed tannin).

### (Results)

The chemical analysis results during the fermentation process and at the termination of fermentation are shown in FIGS. 19 to 21. In the Figures, FIG. 19 shows the fermentability improvement effect of different tannic acids (transition of number of floating cells during the main fermentation); FIG. 20 shows the fermentability improvement effect of different tannic acids (transition of extract consumption during the main fermentation); and FIG. 21 shows the fermentability improvement effect of different tannic acids (analysis value of acetaldehyde at day 7 of the main fermentation). As it is shown in the Figures, the number of floating yeast during the intermediate to late phase of ferementation increased and extract consumption was promoted by adding the above tannic acids (FIGS. 19 and 20). Particularly, the extract consumption improvement effect of tara-tannin was high, and a higher effect was obtained compared to other tannic acids. Acetaldehyde at the termination of the main fermentation was reduced for gallotannin, tara-tannin and persimmon tannin (FIG. 21).

### INDUSTRIAL APPLICABILITY

According to the method for improving fermentability of PYF malt of the present invention, the poor fermentation when using PYF malt can be effectively improved, and the problems arising when using PYF malt can be resolved by ensuring the floating yeast on the way of fermentation, promoting extract (sugar) consumption, and reducing bad odor and taste derived from poor fermentation, etc. and it is possible to manufacture beer or HAPPOSHU having the intended quality. Therefore, with the method of the present invention, problems for treating PYF malt such as disposal of malt, long period storing of PYF malt in silo can be avoided, and realistic and effective treatment of PYF malt in the manufacture of beer or HAPPOSHU can be realized. Therefore, the quality of malt and the cost problem in the manufacture of beer and HAPPOSHU can be significantly improved.

1. A method for improving fermentability of premature yeast flocculation malt, comprising adding and mixing tannic acid to wort and/or yeast to be used for fermentation in the manufacture of beer or HAPPOSHU using premature yeast flocculation malt.

2. The method for improving fermentability of premature yeast flocculation malt according to claim 1, wherein the tannic acid is 1 or more tannic acid selected from gallotannin, tara-tannin, gallic tannin, and persimmon tannin.

3. The method for improving fermentability of premature yeast flocculation malt according to claim 1 or 2, wherein the addition of tannic acid is an addition to wort before addition of yeast, or an addition to wort fermentation solution after addition of yeast, or an addition to yeast for adding to wort in the manufacture step of beer or HAPPOSHU.

4. The method for improving fermentability of premature yeast flocculation malt according to claim 3, comprising adding gallotannin at a rate of 0.1 to 3.9 g/kg malt relative to wort before addition of yeast.

5. The method for improving fermentability of premature yeast flocculation malt according to claim 3, comprising adding gallotannin at a rate of 0.1 to 3.9 g/kg centrifuged yeast (2000 G·10 min) relative to wort fermentation solution after addition of yeast.

6. The method for improving fermentability of premature yeast flocculation malt according to claim 3, comprising adding gallotannin at a rate of 0.01 to 0.19 g/kg centrifuged yeast min) relative to yeast solution for adding to wort.

7. A method for manufacturing beer or HAPPOSHU using premature yeast flocculation malt, comprising adding and mixing tannic acid to wort before addition of yeast, wort fermentation solution after addition of yeast, or yeast for adding to wort, and allowing fermentation with yeast in the manufacturing step of beer or HAPPOSHU, in the manufacture of beer or HAPPOSHU using premature yeast flocculation malt.
